(19) United States
(12) Patent Application Publication
(10) Pub. No.: US 2017/0175705 A1
(43) Pub. Date: Jun. 22, 2017

(54) FLUID INTERFACE DEVICES WITH STABILIZATION FEATURES AS WELL AS AIRFOIL ASSEMBLIES INCLUDING SAME

(71) Applicant: Theodore M. Garver, Springboro, PA (US)

(72) Inventor: Theodore M. Garver, Springboro, PA (US)

(21) Appl. No.: 15/388,958

(22) Filed: Dec. 22, 2016

Related U.S. Application Data
(60) Provisional application No. 62/271,202, filed on Dec. 22, 2015.

(51) Int. Cl. F03D 1/06; B64C 23/02; B64C 23/00; B64C 3/00

(52) U.S. Cl. CPC F03D 1/0675; B64C 3/00; B64C 23/02; B64C 23/005; F05B 2240/221; F05B 2240/311; F05B 2260/966

(57) ABSTRACT

Fluid interface device, such as may be used in association with airfoil assemblies, can include at least one movable band oriented such that the band moves in a direction relative to an associated relative fluid flow. The at least one movable band can be supported such that at least a portion of an outer surface of the movable band is exposed to the associated relative fluid flow. Fluid interface devices can also include one or more lateral stabilization features operative to oppose lateral migration-inducing forces on the at least one movable band that may be experienced during use of the fluid interface device in the associated relative fluid flow. Airfoil assemblies including such fluid interface devices, as well as vehicles and a wind turbines including one or more of such airfoil assemblies are also included.

This application claims the benefit of U.S. Provisional Application No. 62/271,202, filed Dec. 22, 2015, the contents of which is hereby incorporated herein by reference in its entirety.

### BACKGROUND

The subject matter of the present disclosure broadly relates to the art of fluid interface devices, such as airfoil structures, for example, used in connection with the relative movement of fluid, and, more particularly, to fluid interface devices that include one or more moving bands with one or more lateral stabilization features operatively associated therewith to promote tracking and alignment during displacement and use.

The subject matter of the present disclosure finds particular application and use in connection with airfoil structures, such as wings of aircrafts and blades of wind turbines, and is shown and described herein with particular reference thereto. It will be appreciated, however, that the subject matter of the present disclosure is amenable to use in a variety of other applications and/or environments, such as air moving devices (e.g., fans) and other power generation systems (e.g., turbines), for example. As such, it is to be understood that the specific reference herein to use on and/or in association with aircraft wings and wind turbines is merely exemplary of such use and is not intended to be in any way limiting.

The use of fluid interface devices, such as aircraft wings and wind turbine blades, for example, to convert forces imparted by fluid flowing along or across a fluid interface device into forces useful for performing work are well known. Nonetheless, efforts to improve the performance of such fluid interface devices continue to be made. One example of such an effort relates to constructions for improving the performance of aircraft, and is disclosed in U.S. Pat. No. 6,824,109 to Garver. Another example of such an effort is broadly disclosed in connection with constructions for improving the performance of wind turbines, and is disclosed in U.S. Patent Application Publication 2009/0148290 to Garver.

Under ideal conditions, moving bands of a fluid interface device, such as for an airfoil structure, for example, will track or otherwise maintain a predetermined lateral position as the moving bands undergo displacement around or otherwise along the associated airfoil structure, such as a wing of an aircraft or a blade of a wind turbine, for example. In practice, however, it has been found that such moving bands may tend to migrate laterally to one side or the other as a result of various forces and/or misalignments that may be induced or otherwise occur during use. Such migration can undesirably result in the occurrence of disadvantageous conditions associated with the moving band. As one example, physical contact could disadvantageously occur between an outside edge of the moving band and an adjacent airfoil structure or other component associated therewith. In some cases, such physical contact could result in reduced performance and/or the occurrence of other undesirable characteristics associated with the operation of the fluid interface device.

Therefore, notwithstanding the prior development and overall success of any known constructions, it is believed desirable to develop fluid interface devices that are operative to overcome the foregoing and/or other disadvantages, and/or otherwise advance the art of fluid interface devices.

### INCORPORATION BY REFERENCE

The entire contents of the following documents are hereby incorporated herein by reference:

U.S. Pat. No. 6,322,024, which issued on Nov. 27, 2001, entitled LIFT MULTIPLYING DEVICE FOR AIRCRAFT by Garver;

U.S. Pat. No. 6,824,109, which issued on Nov. 30, 2004, entitled LIFT ADJUSTING DEVICE FOR AIRCRAFT by Garver;

U.S. Patent Application Publication No. 2009/0148290, which was filed as U.S. Ser. No. 12/372,371 on Feb. 17, 2009 and published on Jun. 11, 2009, entitled WIND TURBINE AND METHOD OF OPERATING SAME by Garver; and

U.S. Pat. No. 9,394,046, which issued on Jul. 19, 2016, entitled FLUID INTERFACE DEVICE AS WELL AS APPARATI AND METHODS INCLUDING THE SAME by Garver.

### BRIEF DESCRIPTION

One example of a fluid interface device in accordance with the subject matter of the present disclosure can be operatively disposed along an associated airfoil structure for use in an associated fluid such that relative movement between the fluid interface device and the associated fluid can result in an associated fluid flow across the fluid interface device such that the associated fluid flow can have an associated flow direction. The associated airfoil structure can include an associated first longitudinal edge and an associated second longitudinal edge that is spaced apart from the associated first longitudinal edge in approximately the associated flow direction. The fluid interface device can include a first roller disposed toward the associated first longitudinal edge and a second roller that is spaced apart from the first roller such that the second roller is disposed toward the associated second longitudinal edge relative to the first roller. The fluid interface device can also include at least one movable band supported between the first and second rollers, and oriented such that the at least one movable band can be displaced in relation to the associated flow direction with a surface portion of the at least one movable band exposed along an associated side of the associated airfoil structure. The fluid interface device can further include at least one lateral stabilization feature operatively engaging the at least one movable band and operative to oppose lateral migration-inducing forces on the at least one movable band such as may be incurred during operation of the fluid interface device.

One example of an airfoil assembly in accordance with the subject matter of the present disclosure can be operated in an associated gaseous fluid such that relative movement between the airfoil assembly and the associated gaseous fluid can result in an associated gaseous fluid flow across the airfoil assembly in an associated flow direction. The airfoil assembly can include an airfoil structure and at least one fluid interface device operatively associated with the airfoil structure. The airfoil structure can include a first longitudinal edge and a second longitudinal edge that is spaced apart from the first longitudinal edge in approximately the associated flow direction as well as a first side and a second side facing opposite the first side. The at least one fluid interface device can include a first roller disposed toward the first longitudinal edge and a second roller that is spaced apart from the first roller such that the second roller is disposed toward the second longitudinal edge relative to the first roller. The fluid interface device can also include at least one movable band supported between the first and second rollers, and oriented such that the at least one movable band can be displaced in relation to the associated flow direction with an exterior surface portion of the at least one movable band exposed along at least one of the first and second sides of the airfoil structure. In this manner, the one or more movable bands can be supported on the airfoil structure such that, during operation, a relative velocity can be maintained between an exterior surface portion of the at least one movable band and at least one of the first and second sides of the airfoil structure.

In some cases, the first and second sides of the airfoil structure can have approximately linear cross-sectional profiles, and can extend in an approximately parallel orientation relative to one another between the first and second longitudinal edges. In other cases, the first and second sides of the airfoil structure can extend between the first and second longitudinal edges at an acute angle relative to one another. In such cases, the first side of the airfoil structure can have one of an approximately linear cross-sectional profile and a convex cross-sectional profile, and the second side of the airfoil structure can have an approximately linear cross-sectional profile.

In any one or more of the foregoing constructions of an airfoil structure, the first roller of the at least one fluid interface device can, in some cases, be disposed along and at least partially forming the first longitudinal edge of the airfoil structure and the second roller can be disposed along and at least partially forming the second longitudinal edge of the airfoil structure. In such cases, the airfoil assembly can, optionally, include a cover wall extending along at least a portion of the first longitudinal edge and at least a portion of the first side of the airfoil structure thereby covering at least a section of the exterior surface portion of the at least one movable band as the at least one movable band is displaced during use.

Additionally, or in the alternative, in any one or more of the foregoing constructions of an airfoil structure, the first roller can be disposed in spaced relation to the first longitudinal edge of the airfoil structure and the second roller can be disposed in spaced relation to the second longitudinal edge of the airfoil structure. In such cases, the first roller is spaced inwardly toward the second longitudinal edge and the second roller is spaced inwardly toward the first longitudinal edge with the first and second rollers also being disposed in spaced relation to one another. In a preferred arrangement of such a construction, a section of the exterior surface portion of the at least one movable band will be exposed along one of the first and second sides of the airfoil structure with the remainder of the exterior surface portion of the at least one movable band disposed within an interior of the airfoil structure.

The one or more fluid interface devices of an airfoil assembly according to any one or more of the four foregoing paragraphs can further include at least one lateral stabilization feature operatively engaging the at least one movable band and operative to oppose lateral migration-inducing forces on the at least one movable band such as may be incurred during operation of the fluid interface device.

One example of an airplane in accordance with the subject matter of the present disclosure can include at least one airfoil assembly in accordance with the foregoing paragraph.

One example of a wind turbine in accordance with the subject matter of the present disclosure can include at least one airfoil assembly in accordance with the foregoing paragraph.

### BRIEF DESCRIPTION OF THE DRAWINGS

FIG. 1 is a front view of an airplane that includes one or more airfoil assemblies in accordance with the subject matter of the present disclosure.

FIG. 2 is a top view of the airplane in FIG. 1.

FIG. 3 is a side view of the airplane in FIGS. 1 and 2.

FIG. 4 is a front view of a wind turbine that includes a plurality of airfoil assemblies in accordance with the subject matter of the present disclosure.

FIG. 5 is a cross-sectional side view schematically illustrating one example of an airfoil assembly in accordance with the subject matter of the present disclosure.

FIG. 6 is a cross-sectional side view schematically illustrating another example of an airfoil assembly in accordance with the subject matter of the present disclosure.

FIG. 7 is a cross-sectional side view schematically illustrating still another example of an airfoil assembly in accordance with the subject matter of the present disclosure.

FIG. 8 is a cross-sectional side view schematically illustrating still a further example of an airfoil assembly in accordance with the subject matter of the present disclosure.

FIG. 9 is a perspective view schematically illustrating one example of a fluid interface device in accordance with the subject matter of the present disclosure.

FIG. 10 is a top plan view schematically representing a fluid interface device including one or more representations of lateral stabilization features operatively associated therewith.

FIG. 11 is a cross-sectional side view of the fluid interface device in FIG. 10 and schematically illustrating one or more representations of lateral stabilization features in accordance with the subject matter of the present disclosure.

FIG. 12 is an enlarged view, in partial cross section, of one example of a lateral stabilization feature in accordance with the subject matter of the present disclosure.

FIG. 13 is an enlarged view, in partial cross section, of another example of a lateral stabilization feature in accordance with the subject matter of the present disclosure.

FIG. 14 is an enlarged view, in partial cross section, of still another example of a lateral stabilization feature in accordance with the subject matter of the present disclosure.

FIG. 15 is an enlarged view, in partial cross section, of a further example of a lateral stabilization feature in accordance with the subject matter of the present disclosure.

FIG. 16 is an enlarged view, in partial cross section, of still a further example of a lateral stabilization feature in accordance with the subject matter of the present disclosure.

FIG. 17 is an enlarged view, in partial cross section, of yet a further example of a lateral stabilization feature in accordance with the subject matter of the present disclosure.

### DETAILED DESCRIPTION

Referring now in greater detail to the drawings, it is to be understood that the illustrations referenced herein are for the purposes of demonstrating examples of embodiments of the subject matter of the present disclosure and that these illustrations and examples are not intended to be in any way limiting. Additionally, it should be recognized and appreciated that the drawings are not to scale, and that the proportions and/or combinations of certain features and/or elements may be exaggerated, excluded, or isolated for purposes of clarity and ease of understanding.

An airfoil assembly together with any one or more fluid interface devices thereof, in accordance with the subject matter of the present disclosure, is generally adapted for use in association with a fluidic environment such that relative movement between the airfoil assembly (and any fluid interface devices thereof) and the associated fluid can result in a fluid flow across the airfoil assembly (and any fluid interface devices thereof). In general, the fluid flow will have a flow direction in relation to this relative movement, and can cause a net force (e.g., lift) to act on the airfoil assembly (and any fluid interface devices thereof) in a direction traverse (e.g., perpendicular) to the flow direction. Any one or more fluid interface devices of the airfoil assembly can also have the effect of increasing or amplifying a net force (e.g., lift) acting on the airfoil assembly (and any fluid interface devices thereof). In some cases, an airfoil assembly will include an airfoil structure that has opposing sides that, in cross section, have different lateral lengths that can act to generate the net force acting on the airfoil assembly, such as is commonly found on aircraft, aerial vehicles, wind turbines, and a variety of other structures and devices.

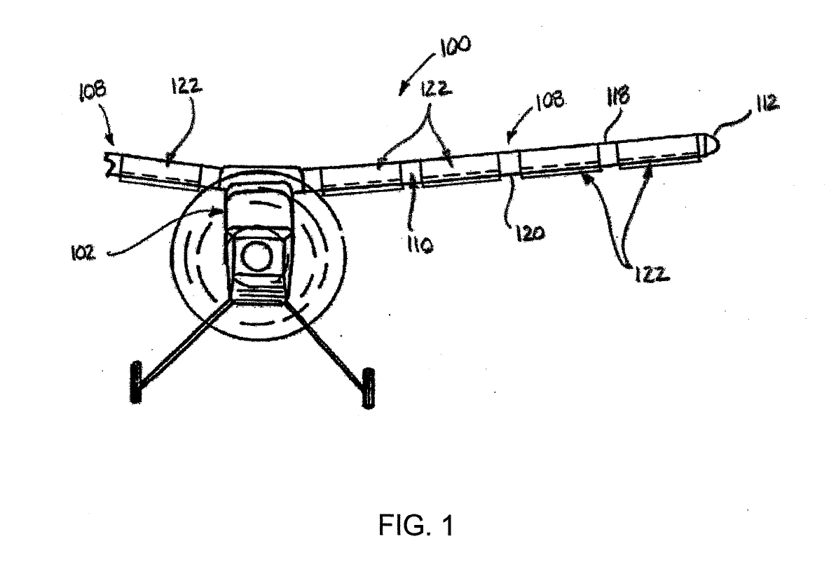

An airfoil assembly in accordance with the subject matter of the present disclosure includes an airfoil structure and at least one fluid interface device. One example of such an airfoil assembly is embodied in an airplane 100, which is illustrated in FIGS. 1-3. Airplane 100 includes a body or fuselage 102 that extends between a front 104 and a rear 106. Additionally, airplane 100 includes at least one airfoil assembly that is adapted for use in a gaseous fluid (e.g., an air atmosphere) such that the relative movement between the airfoil assembly and the gaseous fluid can result in a gaseous fluid flow across the airfoil assembly and thereby cause a net force (e.g., lift) to act on the airfoil assembly. In the case of airplane 100, the airfoil assemblies are embodied as two wing sections 108. The wing sections can include a wing structure 110, which embodies the airfoil structure of the airfoil assembly. Wing structure 110 can have a longitudinal length and can extend lengthwise in opposing directions from along body 102 toward wing tips 112. Wing sections 108 have a first or leading edge 114 and a second or trailing edge 116 that is spaced laterally from the leading edge. Wing sections 108 also include opposing first and second sides 118 and 120, respectively, which extend laterally between the leading and trailing edges of the wing sections. In cross section, first side 116 will sometimes have a longer lateral length than second side 118.

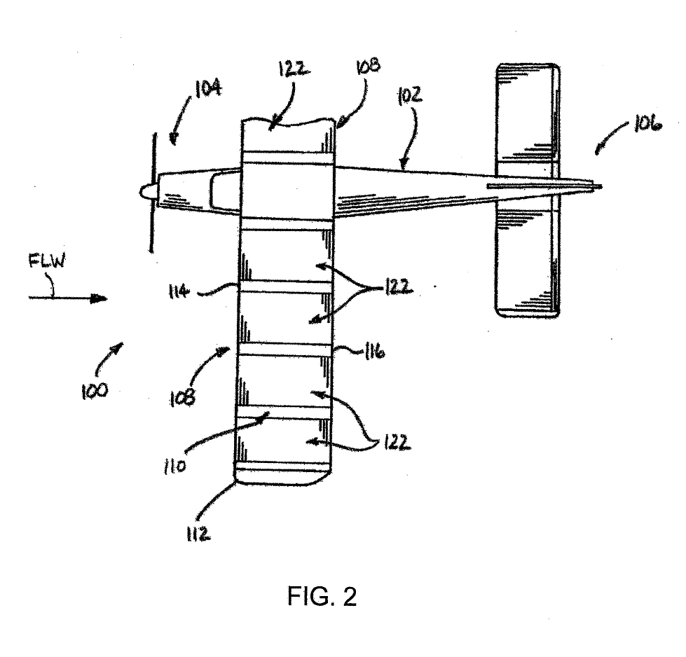

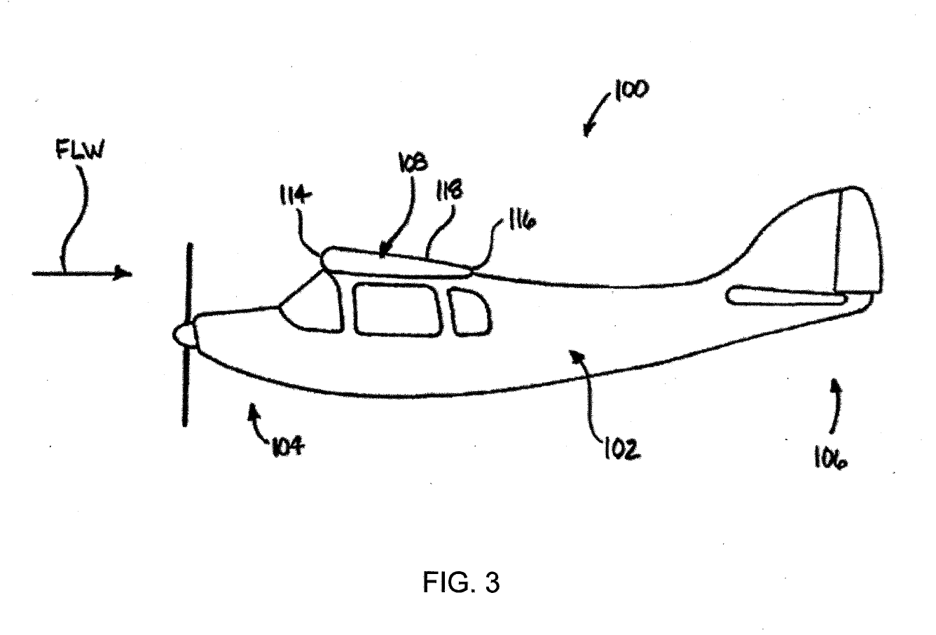

As is well understood, such a cross-sectional shape will result in a net lifting force being generated along the wing sections as the wing sections undergo movement relative to a gaseous fluid, which movement is represented in FIGS. 2 and 3 by arrow FLW. It will be appreciated, however, that a wide variety of cross-sectional shapes for airfoil assemblies could alternately be used, such as are described hereinafter, for example. Additionally, it will be appreciated that wing sections 108 can be secured to body 102 in any suitable manner. As such, it will be understood that the airplane and wing configuration illustrated in FIGS. 1-3 is merely one example of a possible configuration and is not intended to be in any way limiting.

As mentioned above, an airfoil assembly in accordance with the subject matter of the present disclosure will also include one or more fluid interface devices that include a surface that is capable of moving along at least a portion of at least one of the sides of the airfoil assembly. It will be appreciated that any suitable number of movable surfaces can be used, such as a quantity of from 1 to 100 moving surfaces, for example, depending upon the size and shape of the airfoil assembly. In a preferred arrangement, each airfoil assembly can include at least two moving surfaces. Additionally, the one or more movable surfaces can take any suitable form or configuration. As one example, the one or more moving surfaces could take the form of one or more endless bands that are supported on, along, or within the airfoil assembly.

In the exemplary arrangement shown in FIGS. 1-3, airplane 100 is shown as including a plurality of fluid interface devices 122 each of which is shown as including an endless band. The plurality of fluid interface devices can be disposed in spaced relation to one another such that the endless bands are spaced apart along the longitudinal length of wing sections 108.

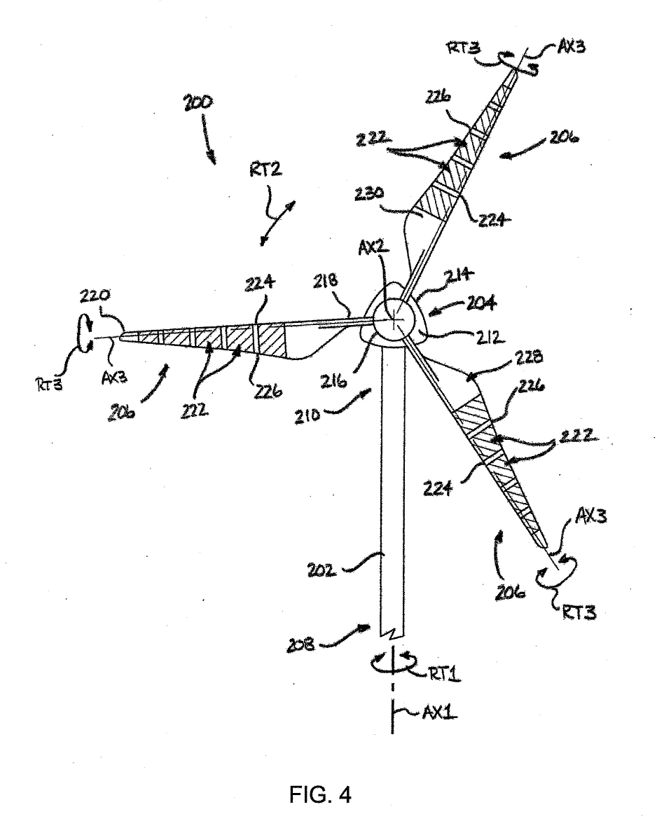

Another example of an airfoil structure in accordance with the subject matter of the present disclosure is embodied in a wind turbine 200, which is illustrated in FIG. 4. Wind turbine 200 includes a support or base structure 202, a turbine body 204 that is supported on the base structure, and at least one turbine blade assembly that is operatively connected to the turbine body. In the exemplary embodiment shown in FIG. 4, the airfoil structures in accordance with the subject matter of the present disclosure are embodied in a plurality of turbine blade assemblies 206 that are shown as being operatively connected to turbine body 204. It will be appreciated that any suitable number of turbine blade assemblies can be supported on the turbine body, such as from one (1) to nine (9) turbine blade assemblies, for example.

Support or base structure 202 is shown in as having an approximately-straight configuration extending longitudinally between a first or lower end 208 and a second or upper end 210. It will be appreciated that the base structure can be of any type, kind, configuration, and/or construction suitable for supporting turbine body 204 and the one or more turbine blade assemblies at a suitable elevation above a supporting foundation (not shown), and that base structure 202 is merely one example of a base structure that could be used. Additionally, it will be appreciated that a wind turbine in accordance with the subject disclosure can be installed at any suitable geographic location. As such, the supporting foundation could, without limitation, be a solid foundation supported by the ground, a seafloor or lake bed, a floating structure on a body of water, or even a rooftop (or other elevated portion) of a building or other structure.

Base structure 202 is shown in as including a longitudinally-extending axis AX1 extending between the first and second ends thereof. Turbine body 204 is shown as being supported on second end 210 and, in a preferred arrangement, is operatively connected to base structure 202 such that the turbine body can be rotated about axis AX1, as represented in FIG. 4 by arrow RT1. In this manner, the turbine body and the one or more turbine blade assemblies supported thereon can be favorably oriented with respect to the direction of the wind. It will be recognized that the favorable orientation of a turbine body and one or more turbine blade assemblies on a wind turbine is generally well understood in the art and that any suitable arrangement and/or system can be used to control the orientation of the turbine body and one or more turbine blade assemblies about axis AX1.

Turbine body 204 includes a first or front end 212, a second or tail end (not shown), and a longitudinal axis AX2 that extends generally between the front and tail ends (i.e., in a direction into the drawing sheet). Turbine body 204 can be oriented in a lengthwise-direction with respect to the wind direction, which will generally have a direction into the drawing sheet, such that front end 212 and turbine blade assemblies 206 are facing in an upstream direction and the tail end (not shown) of the turbine body is disposed in a downstream direction. It will be appreciated, however, that other configurations and/or constructions of wind turbines may operate in a different manner.

Turbine body 204 also includes a first body portion 214 that is supported on the base structure for rotation about axis AX1, as described above, and a second body portion 216 that is supported on the first body portion for rotation about axis AX2. It will be appreciated that second body portion 216 can be supported on first body portion 214 in any suitable manner, such as may be known by those of skill in the art.

A plurality of turbine blade assemblies 206 are operatively connected to second body portion 216 of turbine body 204 for rotation therewith about axis AX2. In general, kinetic energy from fluid flow (i.e. air currents such as from wind) acting on turbine blade assemblies 206 can cause the turbine blade assemblies to impart rotational motion to second body portion 216 of the turbine body. As such, the turbine blade assemblies together with the second body portion of the turbine body rotate about axis AX2, as indicated by arrow RT2.

Additionally, turbine blade assemblies 206 extend radially outward from second body portion 216 between a first or proximal end 218 and a second or distal end 220. A longitudinal axis AX3 extends generally between the proximal and distal ends. In one preferred embodiment, the turbine blade assemblies can be supported on second body portion 216 for rotation about axis AX3, respectively of each turbine blade assembly, as is generally indicated by arrows RT3. Rotation of the turbine blade assemblies about axes AX3 permits favorable orientation of the turbine blade assemblies with respect to the direction of the wind, as is well understood by those of skill in the art. Additionally, it will be appreciated that any suitable arrangement and/or control system can be used to selectively adjust the orientation of the turbine blade assemblies about axes AX3.

As described above, an airfoil assembly in accordance with the subject matter of the present disclosure will also include one or more fluid interface devices that include a surface that is capable of moving along at least a portion of at least one of the sides of the airfoil assembly. It will be appreciated that any suitable number of movable surfaces can be used, such as a quantity of from 1 to 100 moving surfaces, for example, depending upon the size and shape of the airfoil assembly. In a preferred arrangement, each airfoil assembly can include at least two moving surfaces. Additionally, the one or more movable surfaces can take any suitable form or configuration. As one example, the one or more moving surfaces could take the form of one or more endless bands that are supported on, along, or within the airfoil assembly.

In the exemplary arrangement shown in FIG. 4, wind turbine 200 is shown as including a plurality of fluid interface devices 222 each of which is shown as including an endless band. The plurality of fluid interface devices can be disposed in spaced relation to one another along the longitudinal length of turbine blade assemblies 206 such that the movable bands thereof are spaced apart from one another.

With further reference to FIG. 4, turbine blade assemblies 206 can include a turbine blade structure, which embodies the airfoil structure of the airfoil assembly. In a preferred arrangement, at least one surface portion that is disposed along at least one side of the turbine blade and is movable relative to the side of the turbine blade structure such that the relative speed of the movable surface with respect to the wind is different than the relative speed along the side of the turbine blade structure would be at the same longitudinal location. In FIG. 4, turbine blade assemblies 206 include a turbine blade structure 228 and at least one surface (e.g., outer surfaces of the movable bands of fluid interface devices 222) that extends along at least one side of the turbine blade structure and is movable in a direction along that at least one side that is transverse (e.g., perpendicular) to longitudinal axis AX3. In a preferred arrangement, the at least one surface is disposed on only one side of the turbine blade structure 228 and moves against the fluid flow (i.e. air currents such as from wind).

Again, it will be appreciated that an airfoil assembly in accordance with the subject matter of the present disclosure, such as turbine blade assemblies 206, for example, can have any suitable shape or configuration. For example, as shown in FIG. 4, a first or leading edge 224 extends longitudinally along the turbine blade structure and a second or trailing edge 226 extends longitudinally along the turbine blade structure in laterally-spaced relation to the leading edge. Trailing edge 226 is shown as being disposed at an angle relative to leading edge 224, such that a portion of the turbine blade nearer to distal end 220 will have a lesser lateral dimension than a portion of the turbine blade nearer to proximal end 218. As one example, such an arrangement could be due to the turbine blade structure (or wing structure) being tapered in the lateral direction or, as another example, due to the turbine blade structure being twisted along the longitudinal length thereof.

Turbine blade structure 228 also includes a first side 230 and an opposing second side (not shown) that extend laterally between the leading and trailing edges of the turbine blade structure. Depending upon factors such as the shape of the turbine blade assembly, the direction of rotation of the turbine blade assembly about axis AX2 and the angle at which the turbine blade assembly is disposed about axis AX3, one of the first and second sides of the turbine blade may be referred to as a pressure side with the other of the first and second sides being referred to as the suction side of the turbine blade assembly.

It will be appreciated that each of the plurality of fluid interface devices and/or the movable bands thereof can have one of two or more different widths, length, and/or shapes, such as may be due, at least in part, to the shape and/or configuration of an associated airfoil structure. For example, two or more of the fluid interface devices (together with the movable bands thereof) can have different nominal widths and/or lengths. In other cases, however, it will be appreciated that two or more of the plurality of fluid interface devices (together with the movable bands thereof) can, optionally, have the same length and/or width dimensions.

It will be appreciated that the one or more fluid interface devices and be operatively associated with an airfoil structure in any suitable manner. For example, if one or more endless, movable bands are used to form the one or more fluid interface devices, it will be appreciated that the one or more movable bands can be supported on the airfoil structure in any suitable manner and can include any suitable components and/or devices for permitting the one or more movable bands to be conveyed along at least one side of the airfoil structure. For example, one arrangement could utilize a first support element disposed toward the leading edge of the airfoil structure and a second support element disposed in laterally-spaced relation to the first support element in a direction toward the trailing edge of the airfoil structure. The one or more endless, movable bands can then be supported between these laterally-spaced support elements.

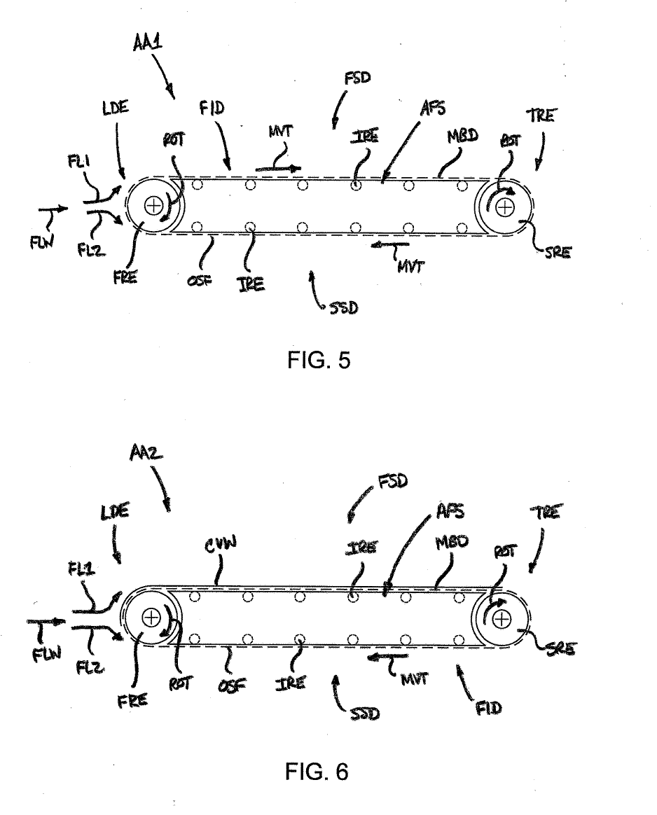

As mentioned above, it will be appreciated that the airfoil structure of an airfoil assembly in accordance with the subject matter of the present disclosure can take any suitable shape or configuration. In such case, any one or more fluid interface devices, such as are described in greater detail hereinafter, can be operatively associated with a suitable airfoil structure examples of which are shown in FIGS. 5-8. With regard to FIG. 5, one example of an airfoil assembly AA1 is shown as including a first or leading edge LDE and a second or trailing edge TRE as well as a first side FSD and a second side SSD facing opposite the first side. Airfoil assembly AA1 includes an airfoil structure AFS in which opposing first and second sides FSD and SSD have approximately linear cross-sectional shapes or profiles, and the first and second sides are oriented in at least approximate alignment (e.g., parallel) with one another. Airfoil assembly AA1 can also include a fluid interface device FID operatively engaged with airfoil structure AFS. As one example, fluid interface device FID can include a first roller element FRE that at least partially defines leading edge LDE as well as a second roller element SRE that is spaced apart from the first roller element and at least partially defines trailing edge TRE. Fluid interface device FID can also include a movable band MBD that extends around airfoil structure AFS and is supported for movement relative thereto by roller elements FRE and SRE. In operation under exposure to relative fluid flow, in a direction represented by arrow FLW, movable band MBD can be displaced relative to airfoil structure AFS, preferably in a direction represented by arrows MVT, through rotation of roller elements FRE and SRE about axes AX thereof in a direction represented by arrows ROT. In some cases, one or more intermediate roller elements IRE can be disposed along first side FSD and/or second side SSD of airfoil structure AFS to operatively engage and support movable band MBD between first roller element FRE and second roller element SRE.

It will be appreciated that, during use, fluid flow will contact leading edge LDE of the airfoil assembly and will be separated into fluid flows FL1 and FL2 that respectively travel along first side FSD and second side SSD of the airfoil assembly. In the arrangement shown in FIG. 5, movable band MBD is displaced around airfoil structure AFS and along first and second sides FSD and SSD of airfoil assembly AA1. As such, it will be recognized that a portion of an outer surface OSF of movable band MBD is displaced along first side FSD in the direction of fluid flow FL1, as indicated by reference arrows MVT while another portion of outer surface OSF of movable band MBD is displaced along second side SSD in the direction opposite fluid flow FL2, as indicated by reference arrows MVT.

FIG. 6 illustrates another example of an airfoil assembly AA2 in accordance with the subject matter of the present disclosure that is shown as being similar in overall configuration to that of airfoil assembly AA1 in FIG. 5. Airfoil assembly AA2 differs from airfoil assembly AA1 at least in that airfoil assembly AA2 includes a cover wall CVW that extends along and across at least a portion of movable band MBD that is disposed along leading edge LDE and first side FSD. In this manner, the portion of movable band MBD that is traveling in the same general direction as fluid flow FLW is largely shielded from exposure to the relative gas flow as well as the performance altering effects thereof. Whereas, airfoil assembly AA1 is shown with the corresponding portion of movable band MBD that is disposed along the leading edge and the first side in FIG. 5 exposed to the full influence and effects of relative gas flow FLW. It will be appreciated that cover wall CVW can be secured on or along airfoil structure AFS in any suitable manner.

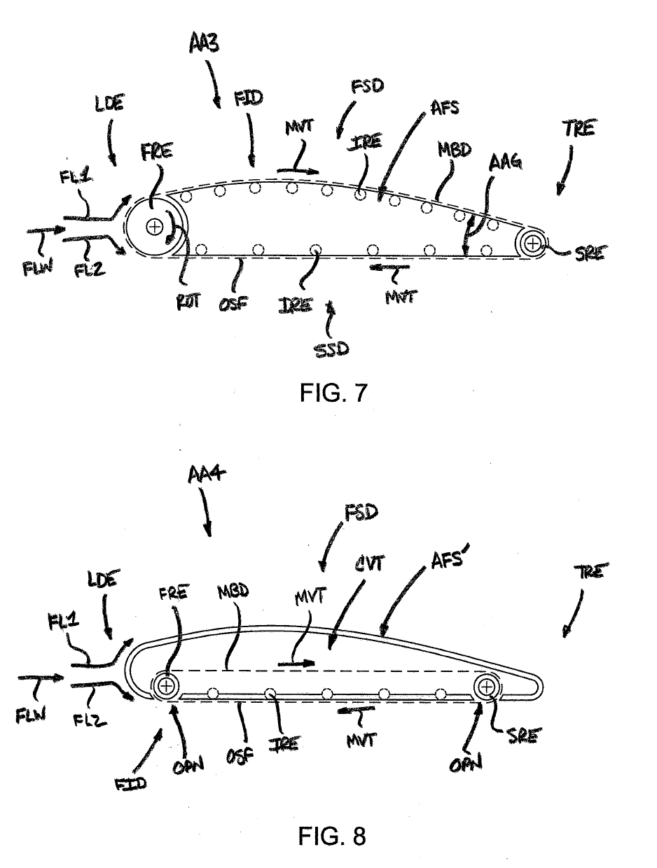

FIG. 7 illustrates yet another example of an airfoil assembly AA3 in accordance with the subject matter of the present disclosure that is shown as being similar in overall construction to that of airfoil assembly AA1 in FIG. 5. Airfoil assembly AA3 differs from airfoil assembly AA1 at least in that first side FSD is shown as having a convex cross-sectional shape or profile while second side SSD has an approximately linear cross-sectional shape or profile. As a result, at least a portion of first side FSD can be disposed at an acute angle relative to second side SSD, as is represented by angular reference dimension AAG in FIG. 7. In some cases, second roller element SRE can be of a different (e.g., smaller) size than first roller element FRE, such as is shown in FIG. 7, for example.

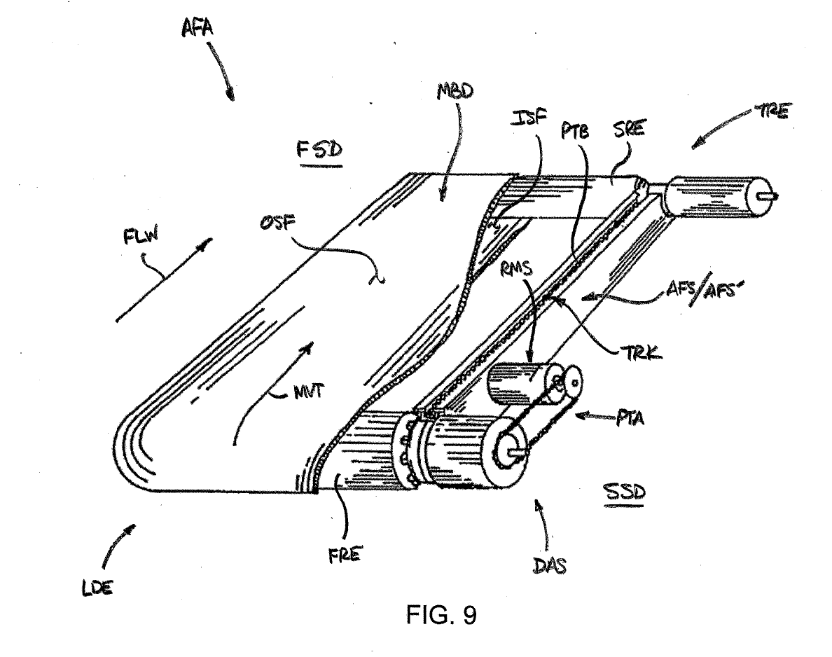

FIG. 8 illustrates still another example of an airfoil assembly AA4 in accordance with the subject matter of the present disclosure that includes first or leading edge LDE, second or trailing edge TRE, first side FSD and second side SSD, as previously described. Additionally, it will be recognized that first side FSD has a convex cross-sectional shape or profile, such as has been described in detail in connection with airfoil assembly AA3 in FIG. 7. Airfoil assembly AA4 differs from the airfoil assemblies AA1, AA2 and AA3 at least in that airfoil assembly AA4 includes an airfoil structure AFS' that at least partially defines leading edge LDE and trailing edge TRE. Additionally, airfoil structure AFS' at least partially defines an internal structure cavity CVT within which at least a portion of movable band MBD is disposed. Furthermore, first and second roller elements FRE and SRE are shown as being spaced toward one another as well as, respectively, away from leading and trailing edges LDE and TRE in comparison with the arrangements shown in FIGS. 5-7. Airfoil structure AFS' includes openings OPN disposed in spaced relation to one another with first roller element FRE disposed adjacent one of the openings and second roller element SRE disposed adjacent the other one of openings OPN. In this manner a portion of movable band MBD can be exposed along the exterior of second side SSD, preferably traveling against relative fluid flow FFL (i.e., from along second roller element SRE toward first roller element FRE) as is represented by arrows MVT. At any given time, the remainder of movable band MBD is disposed within structural cavity CVT. Thus, the remainder of movable band MBD that is traveling a generally common direction with relative fluid flow FFL (i.e., away from first roller element FRE toward second roller element SRE) is shielded from exposure to the relative fluid flow as well as the performance altering effects thereof.

It will be appreciated that the one or more fluid interface devices of an airfoil assembly in accordance with the subject matter of the present disclosure can be driven or operated in any suitable manner and through the use of any suitable control systems and/or devices. One example of a suitable construction is shown in FIG. 9 in which an airfoil assembly AFA, which is representative of airfoil assemblies AA1-AA4 as well as wing sections 108 and turbine blade assemblies 206, can include first roller element FRE disposed toward leading edge LDE and second roller element SRE disposed toward trailing edge TRE. Airfoil assembly AFA also includes first and second sides FSD and SSD with an airfoil structure AFS (or AFS′) disposed therebetween. Movable band MVB is operatively connected between the first and second roller elements such that rotation of the roller element results in movable band MVB being conveyed or otherwise displaced along at least one of the first and second sides of the airfoil assembly, such as has been described above, for example.

Movable band MVB is shown as having an inner surface ISF disposed toward and abuttingly engaging first and second roller elements FRE and SRE. Movable band MVB is also shown as having an outer surface OSF that interfaces with the fluid, which is indicated as moving relative to airfoil assembly ASA in a direction represented by arrow FLW. As indicated above, it will be appreciated that the one or more fluid interface devices in accordance with the subject matter of the present disclosure can be driven or otherwise operated in any suitable manner and through the use of any suitable systems and/or devices. As one example, airfoil assembly ASA is shown in FIG. 9 as including a drive assembly DAS that can be supported on or along airfoil structure AFS (or AFS′), and can be operatively engaged with one or more of first roller element FRE and/or second roller element SRE. In the arrangement shown in FIG. 9, airfoil assembly ASA includes a rotational motion source RMS, such as a motor, for example, that is operatively connected to first roller element FRE in a suitable manner, such as by way of a power transmission belt and pulley arrangement PTA, for example. In this manner, first roller element can operate as a primary or drive roller for the fluid interface device. In some cases, the second roller element can be an unpowered or idler roller that rotates as a result of the displacement of movable band MBD, which is tensioned or otherwise operatively connected between the first and second roller elements. In other cases, second roller element SRE can be drivably connected to first roller element FRE in a suitable manner, such as by way of a power transmission belt PTB or other component operatively connected between the first and second roller elements. In some cases, airfoil structure AFS (or AFS′) can include a guide track TRK or other alignment maintaining arrangement to receive and/or assist with tracking of power transmission belt PTB during use. In operation, movable band MBD can be displaced around and/or along airfoil structure AFS (or AFS′) in the direction represented by arrow MVT. As such, it will be recognized that the outer surface OSF of the movable band can be displaced along at least second side SSD in the direction opposite (i.e., against) fluid flow FLW.

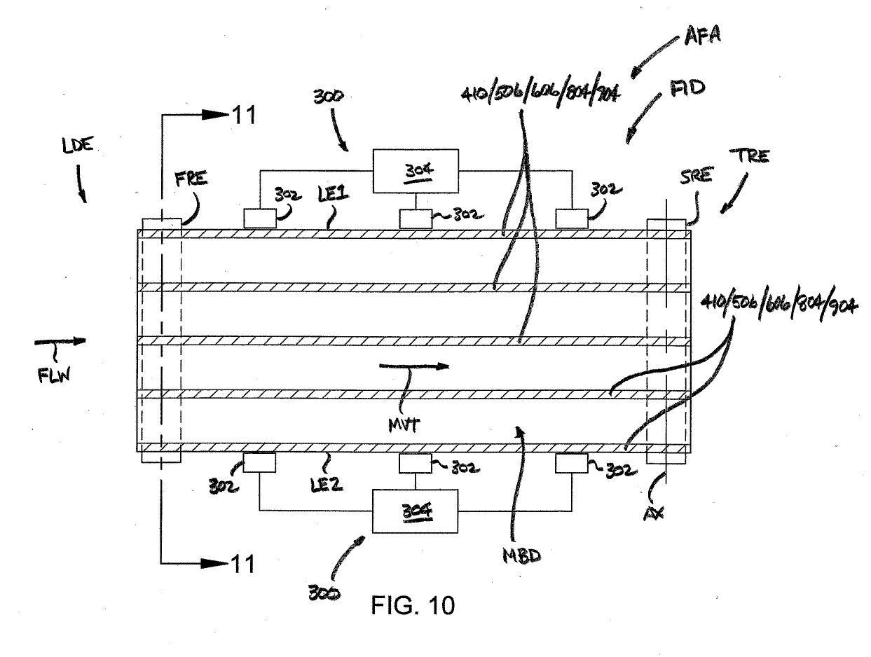

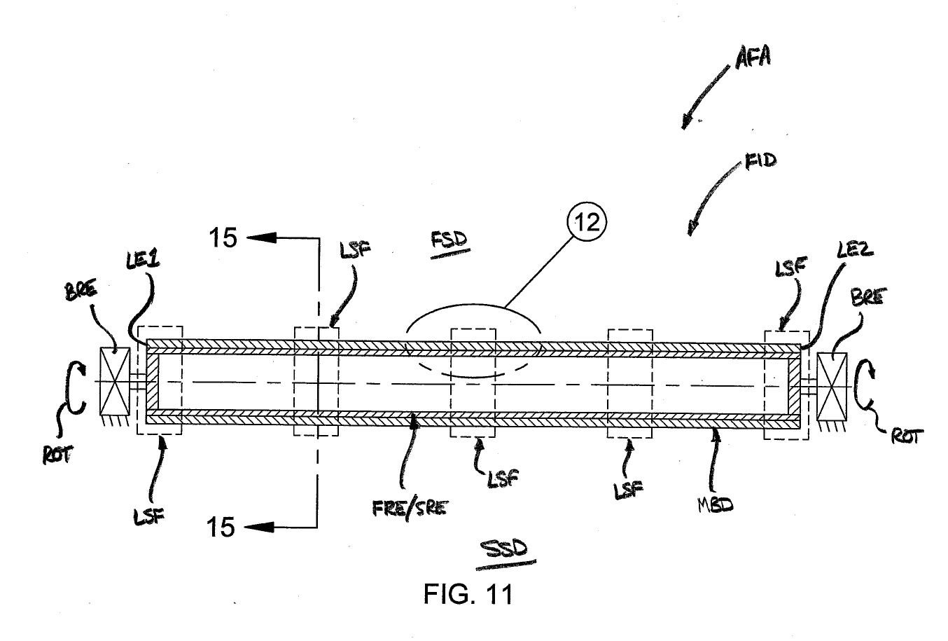

With reference, now, to FIGS. 10 and 11 as well as further reference to airfoil assembly AFA, which—as indicated above—is representative of airfoil assemblies AA1-AA4 as well as wing sections 108 and turbine blade assemblies 206, fluid interface device FID, in accordance with the subject matter of the present disclosure, can include one or more lateral (with respect to the fluid interface device) stabilization features operatively associated with movable band MBD. It will be appreciated that the one or more lateral stabilization features can be of any suitable type, kind and/or configuration that is operative to inhibit or at least reduce the migration of movable band MBD laterally along the first and second roller elements during use in operation. Such lateral migration of a movable band or belt during use is sometimes referred as “creep” or “creeping”. It will be appreciated that, in some cases, two or more lateral stabilization features of different types and/or kinds may be employed.

One example of a lateral stabilization feature 300 in accordance with the subject matter of the present disclosure operatively disposed along one or more of lateral edges LE1 and LE2 of movable band MBD. In the arrangement shown in FIG. 10, two lateral stabilization features 300 are included with one disposed along lateral edge LE1 and the other disposed along lateral edge LE2. Lateral stabilization feature 300 can include one or more lateral engagement features 302 disposed along lateral edges LE1 and/or LE2. Lateral engagement features 302 are shown as being positioned to selectively engage a corresponding lateral edge of movable band MVB, and thereby inhibit or reduce lateral migration of the movable band during use in operation. In some cases, the lateral engagement features can be disposed in a substantially fixed position, such as on or along the airfoil structure, for example. In other cases, lateral engagement features 302 can be selectively adjustable such that the features may engage a lateral edge to a greater or lesser degree. In such arrangements, one or more control devices 304 can be operatively connected with lateral engagement features 302, and can be operative to modulate or otherwise adjust the performance of lateral stabilization feature 300. In specific arrangements, lateral engagement features 302 could be bearing elements or ball bearings, and control device 304 can be an actuator operatively connected to one or more of the lateral engagement features for selective adjustment thereof.

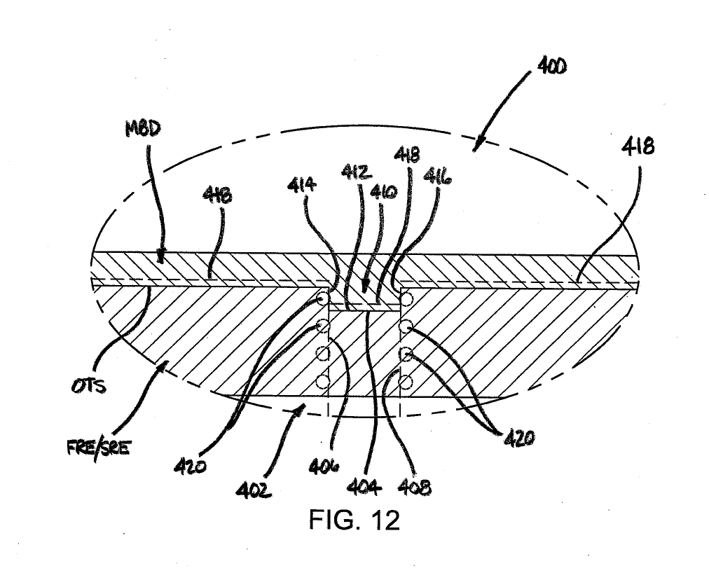

Additionally, or as an alternative to lateral stabilization feature 300, an airfoil structure in accordance with the subject matter of the present disclosure, such as airfoil assembly AFA, which—as indicated above—is representative of airfoil assemblies AA1-AA4 as well as wing sections 108 and turbine blade assemblies 206, can include one or more lateral stabilization features LSF that result from interengagement between movable band MBD and one or more of first roller element FRE and second roller element SRE. Non-limiting examples of types and kinds of such lateral stabilization features are shown and described herein in greater detail in connection with FIGS. 12-17 as well as in further reference to FIGS. 10 and 11. It will be appreciated that any suitable number of one or more lateral stabilization features LSF can be used. For example, a plurality of lateral stabilization features LSF are shown in FIG. 11 as being disposed in spaced relation to one another with one lateral stabilization feature LSF disposed along each of lateral edges LE1 and LE2. Additionally, or in the alternative, a lateral stabilization feature LSF can be disposed along a central portion of movable band MBD. Additionally, or as a further alternative, lateral stabilization features LSF disposed in intermediate positions between the central portion of movable band MBD and lateral edges LE1 and LE2. Additionally, it will be appreciated that any combination of one or more types and/or kinds of lateral stabilization features LSF could be used.

FIGS. 10 and 11 show first roller element FRE supported between bearing elements BRE for rotation about a laterally-extending axis AX, as is represented by arrow ROT in FIG. 11. One example of a lateral stabilization feature 400 of the type resulting from dynamic interengagement between movable band MBD and at least one of first and second roller elements FRE and SRE is shown in FIG. 12 as including an annular engagement feature 402 formed on or along the roller element, which is shown as being first roller element FRE in FIG. 12. Annular engagement feature 402 is shown as being an annular channel or groove that extends into first roller element FRE from along an outer surface OTS thereof to a bottom surface 404. Annular engagement feature 402 extends axially between opposing side surfaces 406 and 408 that are oriented transverse (e.g., perpendicular) to laterally-extending axis AX. Movable band MBD can include an elongated engagement feature 410 formed on or along inner surface ISF that is dimensioned to cooperatively engage annular engagement feature 402. Elongated engagement feature 410 can project inwardly from along inner surface ISF to an inner surface portion 412 that extends laterally between opposing side surfaces 414 and 416. In an assembled condition, one or more side surfaces 414 and 416 of elongated engagement feature 410 can abuttingly engage corresponding side surfaces 406 and 408 of annular engagement feature 402 thereby substantially inhibiting lateral migration or “creep” of movable band MBD during use in operation.

In some cases, outer surface OTS of first and/or second roller elements FRE and/or SRE can, optionally, include an abrasive surface as is represented by dashed lines 418. In other arrangements, dashed lines 418 can represent an abrasive surface formed on or along inner surface ISF of movable band MBD. In still other cases, however, it will be appreciated that both the inner surface of the movable band and the outer surface of the first and/or second roller elements can include abrasive surfaces.

It will be appreciated that annular engagement features 402 and elongated engagement features 410 can be of any suitable size, shape and/or configuration, such as having a width and/or depth/height within a range of from approximately 0.05 inches to approximately 0.50 inches in width and/or depth/height. Additionally, in some cases, the side surfaces 406 and 408 can include one or more friction reducing elements and/or features disposed therealong, such as a plurality of bearing elements 420, for example, that could rotate as the elongated engagement feature 410 of movable band MBD engages and disengages annular engagement feature 402, such as to reduce friction and/or improve the life-span of the movable band.

Also, it will be appreciated that any suitable quantity of lateral stabilization features or regions thereof could be used. For example a quantity of at least 20, or at least 50, or at least 100, lateral stabilization features and/or regions could be disposed in a spaced relation across the full width of one or more of the roller elements and/or movable bands. It will be appreciated that in some arrangements, the depth of the channels or grooves can depend on the tension on the endless band and the air conditions expected to be encountered.

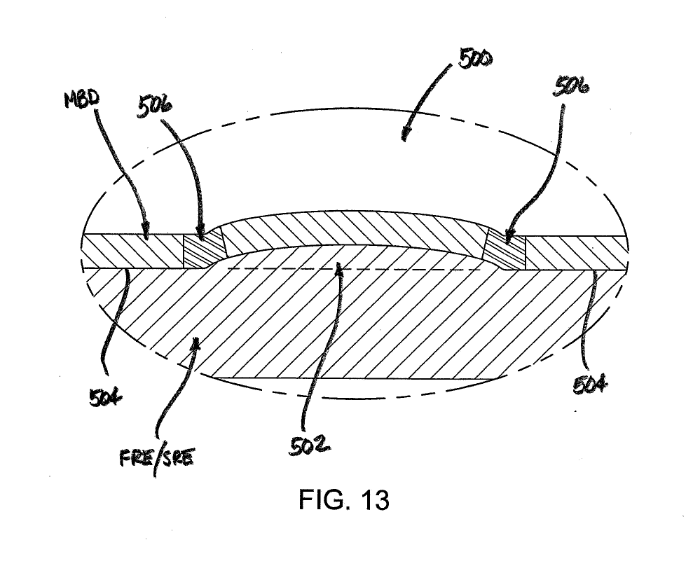

Another example of a lateral stabilization feature 500 of the type resulting from dynamic interengagement between movable band MBD and at least one of the first and second roller elements FRE and SRE is shown in FIG. 13 as including an annular engagement feature 502 formed on or along the roller element, which is shown as being first roller element FRE in FIG. 13. First roller element FRE includes two or more cylindrical surface portions 504 that are spaced apart from one another with annular engagement feature 502 disposed therebetween. In such a construction, annular engagement feature 502 is shown as having a convex cross-sectional shape or profile that extends radially outward from between and operatively interconnects cylindrical surface portions 504 to form a bulge or projection along the roller element. In such a construction, movable band MBD can be at least partially formed from a material having an elongation or stretch that will permit a portion of the movable band to extend around and conform to annular engagement feature 502.

In a preferred arrangement, however, movable band MBD can also include one or more elongated engagement features 506 formed on or along movable band MBD. The one or more elongated engagement features can be dimensioned to operatively engage annular engagement feature 502 and thereby inhibit or at least contribute to the reduction of lateral migration or “creep” of movable band MBD during use in operation. More specifically, elongated engagement features 506 can take the form of at least two sections of alternate band material (or material having an construction resulting in alternate properties) extending around the endless band in laterally-spaced relation to one another. In a preferred arrangement, elongated engagement features 506 can have minimal or at least substantially reduced elongation or stretch relative to the section of material of the movable band that conforms to annular engagement feature 502. By positioning one elongated engagement feature 506 on each side of annular engagement feature 502, the inability to stretch over the increased dimension of the annular engagement feature will promote tracking of the movable band MBD along first and second roller elements FRE and SRE during use and substantially inhibit or at least reduce lateral migration or “creep”.

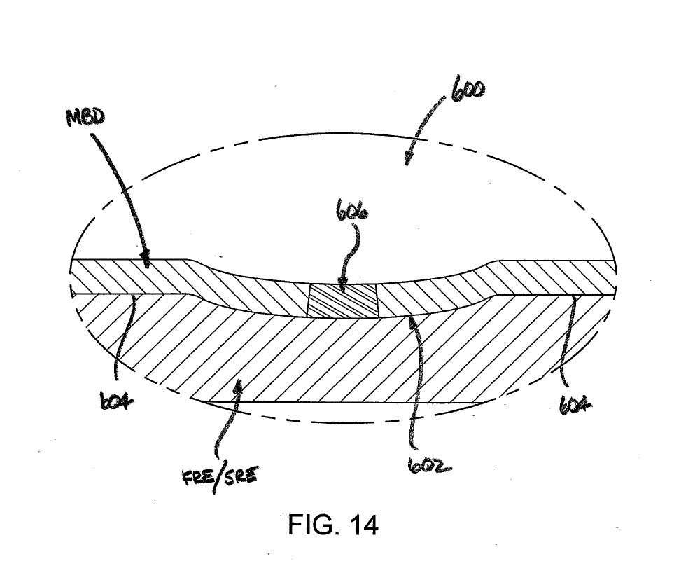

A further example of a lateral stabilization feature 600 of the type resulting from dynamic interengagement between movable band MBD and at least one of the first and second roller elements FRE and SRE is shown in FIG. 14 as including an annular engagement feature 602 formed on or along the roller element, which is shown as being first roller element FRE in FIG. 14. First roller element FRE includes two or more cylindrical surface portions 604 that are spaced apart from one another with annular engagement feature 602 disposed therebetween. In such a construction, annular engagement feature 602 is shown as having a concave cross-sectional shape or profile that extends radially inward from between and operatively interconnects cylindrical surface portions 604 such that a contoured groove or channel is formed into the roller element. In such a construction, movable band MBD can be at least partially formed from a material having an elongation or stretch that will permit at least a portion of the movable band to conform to the contours of annular engagement feature 602.

In a preferred arrangement, however, movable band MBD can also include at least one elongated engagement feature 606 formed on or along movable band MBD. The at least one elongated engagement feature can be dimensioned to operatively engage annular engagement feature 602 and thereby inhibit or at least contribute to the reduction of lateral migration or “creep” of movable band MBD during use in operation. More specifically, elongated engagement feature 606 can take the form of a section of alternate band material (or material having an construction resulting in alternate properties) extending around the endless band. In a preferred arrangement, elongated engagement feature 606 can have minimal or at least substantially reduced elongation or stretch relative to the section of material of the movable band that conforms to a remaining portion of the roller element. By positioning elongated engagement feature 606 at or along the root or bottom of annular engagement feature 602, as shown in FIG. 14, the inability of elongated engagement feature 606 to stretch over the increased dimension of the annular engagement feature will promote tracking of the movable band MBD along first and second roller elements FRE and SRE during use and substantially inhibit or at least reduce lateral migration or “creep”.

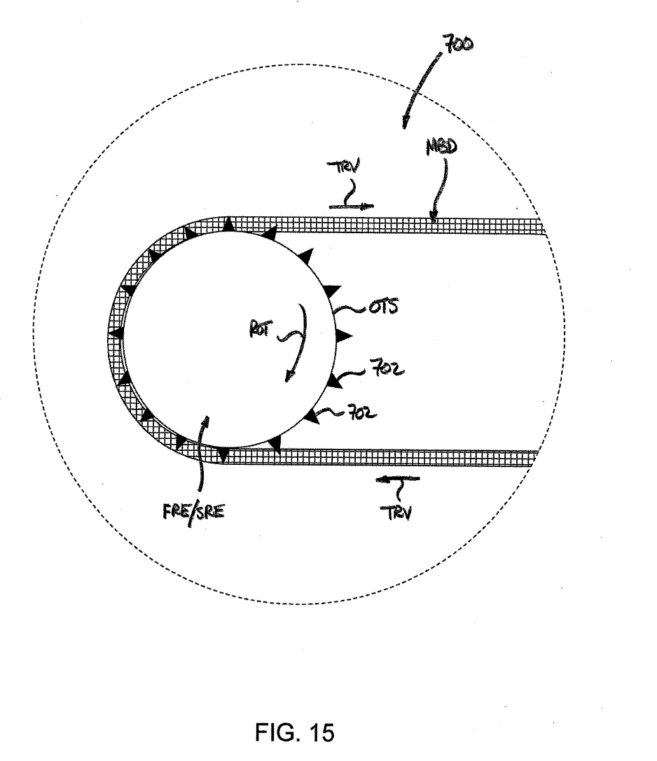

Still another example of a lateral stabilization feature 700 of the dynamic interengagement type between movable band MBD and at least one of the first and second roller elements FRE and SRE is shown in FIG. 15 as including a plurality of protrusions 702 that extend radially outward from along outer surface OTS of the roller element, which is shown in FIG. 15 as being first roller element FRE. In preferred arrangements, protrusions 702 can be, for example, small pointed spikes having a approximately common length dimension. Additionally, lateral stabilization feature 700 can include elongated engagement features 704 in the form of a section of mesh material or a movable band that is at least partially formed from a mesh material or having a mesh surface portion. During use in operation, protrusions 702 rotate into an out of engagement with openings in the mesh material and/or surface as movable band MBD is displaced in the manner discussed above. Such interengagement between protrusions 702 and the movable band material will promote tracking of the movable band MBD along first and second roller elements FRE and SRE during use and substantially inhibit or at least reduce lateral migration or “creep”. In a preferred arrangement, the length dimension of the protrusions can be equal to or slightly less than the thickness of the mesh material. In some cases, a mesh material that is at least partially formed from stainless steel could be used.

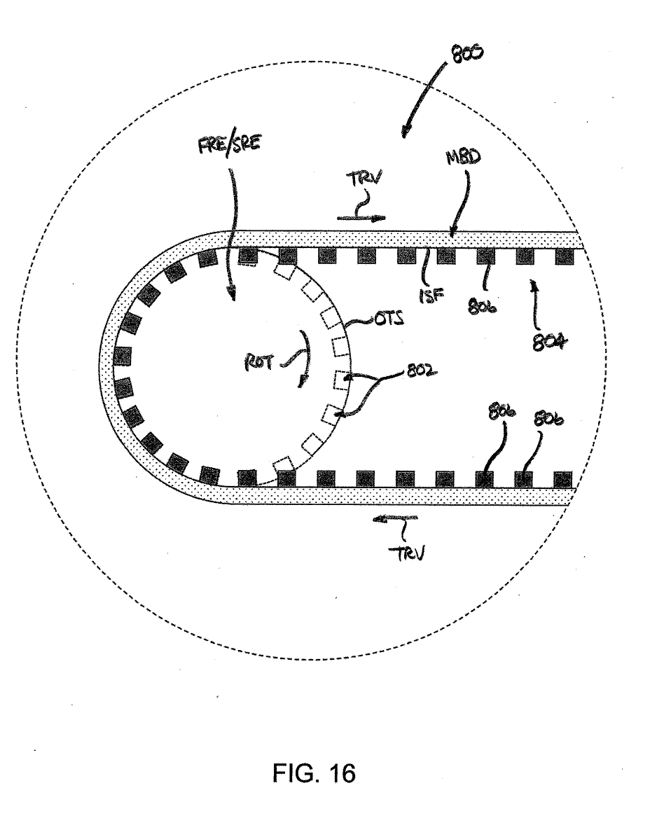

A further example of a lateral stabilization feature 800 of the dynamic interengagement type between movable band MBD and at least one of the first and second roller elements FRE and SRE is shown in FIG. 16 as including a plurality of recesses 802 extending radially inward into the roller element from along outer surface OTS thereof. Additionally, lateral stabilization feature 800 can include one or more elongated engagement features 804 in the form rows of projections 806, such as blocks, for example, that extend radially inward from along inner surface ISF of movable band MBD. During use in operation, projections 806 rotate into an out of engagement with recesses 802 in the roller element as movable band MBD is displaced in the manner discussed above. Such interengagement between projections 806 of the movable band material and recesses 802 of the roller elements will promote tracking of the movable band MBD along first and second roller elements FRE and SRE during use and substantially inhibit or at least reduce lateral migration or “creep”.

As more specific examples, projections 806 can be, for example, flat blades (i.e. blades with a thin longitudinal profile and a wider lateral profile) with the thin profile of the flat blades generally facing the fluid flow, such as air currents (not shown). Additionally, recesses 802 can be long and thin in order to accommodate the flat blades, and designed to insure that the blades meet the holes at every turn of the roller element. In particular, the holes, blades, and roller elements can be positioned exactly such that each turn moves an even number of holes and matches the blades.

Furthermore, areas of movable band MBD around projections 806 can be reinforced in order to resist the sideways force that causes the movable band to walk (i.e. creep). For example, the entire length of the movable band could be reinforced around the holes, rather than just around the holes (i.e. openings), in order to reduce vibrations in the assembly that would otherwise arise from reinforcing just around the holes.

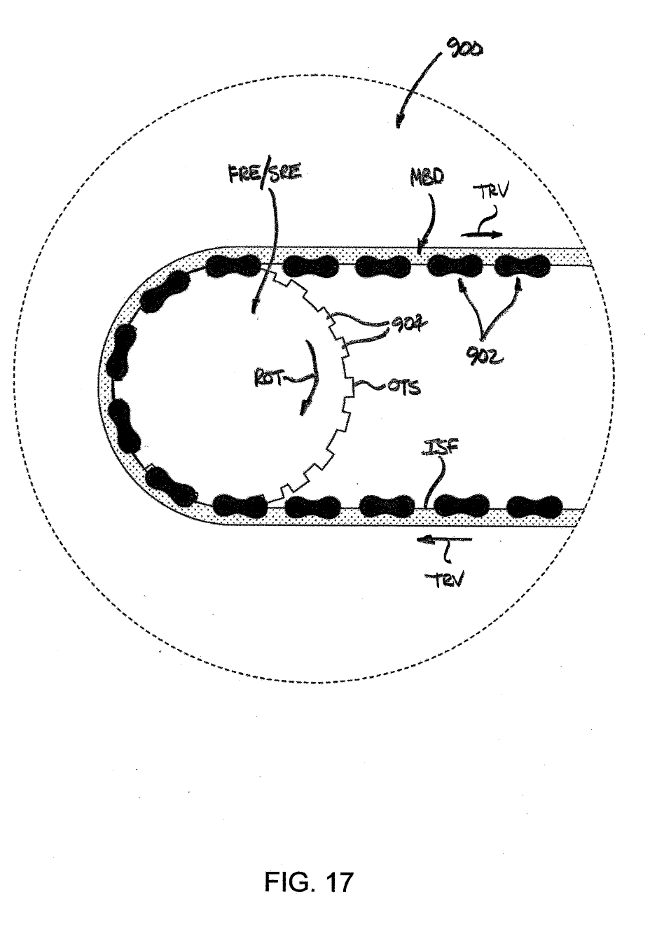

Still a further example of lateral stabilization feature 900 of the dynamic interengagement type between movable band MBD and at least one of the first and second roller elements FRE and SRE is shown in FIG. 17 as including a plurality of sockets 902 embedded into inner surface ISF of movable band MBD, and a plurality of corresponding protrusions 904 extending radially outward along outer surface OTS of roller element, such as roller elements FRE and/or SRE, for example. As movable band MBD travels in the direction indicated by the arrows TRV, protrusions 904 reversibly engages with sockets 902. In preferable arrangements, protrusions 904 can be arranged such that there is always at least one protrusion in contact with the sockets on the movable bands, thereby allowing the movable bands to travel directly on the roller elements. It will be appreciated that this arrangement may allow for less tension on the movable band than other arrangements, which may be desirable in some cases. In further arrangements, sockets 902 may be metal sockets and protrusions 904 may be metal spikes imbedded in the rollers.

It will be appreciated that the fluid interface devices together with the movable bands thereof can be operated and/or controlled in any suitable manner, such as by way of conventional electrical and/or electronic control systems, for example. In a preferred arrangement, a direct current-based system could be used, such as may be suitable for providing substantially infinite variability even with elementary (i.e., simple) control input devices. In operation in connection with airplanes and other mobile devices, each airfoil assembly (e.g., each wing) may have the ability to be controlled separately in order to aid in turning, for example. It will also be appreciated that various surfaces of airplanes and other vehicles and devices can use this technology, including, for example, the horizontal and/or vertical tails of airplanes.

It will be recognized that airfoils, such as airplane wings and turbine blades, for example, of a wide variety of different sizes, shapes, configurations, and constructions have been developed, and that all such variations could not be shown and/or described in the subject disclosure. For example, airplane wings and turbine blades have been developed that include straight edges, tapered edges, curved edges, approximately planar sides, curved sides, symmetrically-shaped sides and asymmetrically-shaped sides. Additionally, some turbine blades are twisted along the longitudinal length thereof such that the wind contacts the turbine blade at different angles at different points along the longitudinal extent of the turbine blade. Notwithstanding all of the many variations of turbine blades, it is to be understood that the subject matter of the present disclosure is broadly capable of use on or otherwise in association with airplane wings and turbine blades of any suitable type, kind, configuration, and/or construction. As such, it is to be understood that the type, kind, size, shape, construction, configuration and/or arrangement of airplane wings and turbine blades shown and described herein are merely exemplary and not intended to be limiting.

As used herein with reference to certain features, elements, components, and/or structures, numerical ordinals (e.g., first, second, third, fourth, etc.) may be used to denote different singles of a plurality of otherwise identify certain features, elements, components and or structures, and do not imply any order or sequence unless specifically defined by the claim language. Additionally, the terms “transverse” and the like, are to be broadly interpreted. As such, the terms “traverse” and the like, can include a wide range of relative angular orientations that include, but are not limited to, an approximately perpendicular angular orientation.

It will also be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus, it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and altercations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. An airfoil assembly operable in an associated relative fluid flow, said airfoil assembly comprising:
an airfoil structure having a longitudinal length and including a first longitudinal edge, a second longitudinal edge spaced laterally from said first longitudinal edge, a first side extending longitudinally along at least a portion of said length between said first and second longitudinal edges, and a second side extending longitudinally along at least a portion of said length between said first and second longitudinal edges and generally opposite said first side; and,
a fluid interface device operatively associated with said airfoil structure, said fluid interface device including:
a first roller element supported along said airfoil structure toward said first longitudinal edge;
a second roller element supported along said airfoil structure in spaced relation to said first roller element in a direction toward said second longitudinal edge of said airfoil structure;
a movable band having a width, said movable band movably supported on said airfoil structure by at least said first and second roller elements such that at least a portion of said movable band is exposed along at least one of said first and second sides of said airfoil structure; and,
a lateral stabilization feature operatively engaging said movable band and operative to oppose lateral migration-inducing forces on said movable band thereby resisting migration of said movable band in a widthwise direction during use in operation of said airfoil assembly.

2. An airfoil assembly according to claim 1, wherein said movable band includes an outer surface and is oriented such that said width extends longitudinally along said airfoil structure, said movable band supported on said airfoil structure such that at least a portion of said outer surface is exposed along at least a portion of at least one of said first and second sides of said airfoil structure such that a relative velocity can be maintained during operation between at least said exposed portion of said outer surface and said at least one of said first and second sides of said airfoil.

3. An airfoil assembly according to claim 2, wherein said exposed portion of said outer surface of said movable band extends along only said second side of said airfoil structure such that said relative velocity is in a direction opposite the associated relative fluid flow.

4. An airfoil assembly according to claim 1, wherein said fluid interface device is one of a plurality of fluid interface devices disposed in longitudinally spaced relation to one another in a lengthwise direction along said airfoil structure.

5. An airfoil assembly according to claim 1, wherein said lateral stabilization feature is one of a plurality of lateral stabilization features operatively associated with said movable band.

6. An airfoil assembly according to claim 5, wherein said plurality of lateral stabilization features include at least 20 lateral stabilization features.

7. An airfoil assembly according to claim 5, wherein said plurality of lateral stabilization features include a first lateral stabilization feature operatively disposed along a first lateral edge of said movable band and a second lateral stabilization feature disposed along a second lateral edge of said movable band.

8. An airfoil assembly according to claim 1, wherein said lateral stabilization feature includes a first interengagement feature operatively associated with said movable band and a second interengagement feature operatively associated with at least one of said first and second roller elements, said first and second interengagement features dynamically engaging one another during use thereby resisting migration of said movable band in said widthwise direction.

9. An airfoil assembly according to claim 8, wherein said first interengagement feature includes an elongated ridge extending inward from along said inner face of said movable band, and said second interengagement feature includes an annular channel extending into at least one of said first and second roller elements with said annular channel dimensioned to receive at least a portion of said elongated ridge operatively engaging said at least one of said first and second roller elements.

10. An airfoil assembly according to claim 9, wherein said annular channel includes a first side and a second side spaced in said widthwise direction from said first side with at least one of said first and second sides of sad annular channel including a bearing element operatively disposed therealong and dimensioned to operatively engage said elongated ridge of said movable band.

11. An airfoil assembly according to claim 8, wherein said second interengagement feature includes an annular projection disposed along at least one of said first and second roller elements, and said first interengagement feature includes first and second sections of comparatively inextensible material disposed along said movable band, said first and second sections of comparatively inextensible material disposed along opposing sides of said annular projection thereby resisting migration of said movable band in said widthwise direction.

12. An airfoil assembly according to claim 8, wherein said second interengagement feature includes an annular recess disposed along at least one of said first and second roller elements, and said first interengagement feature includes a section of comparatively inextensible material disposed along said movable band, said section of comparatively inextensible material disposed within said annular recess thereby resisting migration of said movable band in said widthwise direction.

13. An airfoil assembly according to claim 8, wherein said second interengagement feature includes a plurality of projections extending radially outward from along at least one of said first and second roller elements, and said first interengagment feature includes a plurality of openings disposed along said movable band, said plurality of openings dimensioned to be dynamically interengaged by said plurality of projections during use in operation of said fluid interface device.

14. An airfoil assembly according to claim 8, wherein said second interengagment feature includes a plurality of sockets extending into at least one of said first and second roller elements, and said first interengagment feature includes at least one row of projection elements disposed along said movable band, said projection elements dimensioned for receipt within said plurality of sockets such that dynamic interengagement between said projection elements and said plurality of sockets during use is operative to resist migration of said movable band in said widthwise direction.

15. An airfoil assembly operable in an associated relative fluid flow, said airfoil assembly comprising:
an airfoil structure having a longitudinal length and including a first longitudinal edge, a second longitudinal edge spaced laterally from said first longitudinal edge, a first side extending longitudinally along at least a portion of said length between said first and second longitudinal edges, and a second side extending longitudinally along at least a portion of said length between said first and second longitudinal edges and generally opposite said first side; and,
a fluid interface device operatively associated with said airfoil structure, said fluid interface device including:
a first roller element disposed toward said second longitudinal edge;
a second roller element disposed in spaced relation to said first roller element toward said second longitudinal edge;
a movable band supported between said first and second roller elements, said movable band having a width and extending in a widthwise direction between opposing first and second lateral edges, said movable band including an inner surface operatively engaging said first and second roller elements and an outer surface facing opposite said inner surface, said movable band being displaceable in relation to said airfoil structure such that at least a portion of said outer surface of said movable band is exposed along one of said first side and said second side of said airfoil structure; and,
a lateral stabilization feature disposed along one of said first lateral edge and said second lateral edge of said movable band, and operative to oppose lateral migration-inducing forces on said movable band thereby resisting migration of said movable band in said widthwise direction during use in operation of said airfoil assembly.

16. An airfoil assembly according to claim 15, wherein said lateral stabilization feature is a first lateral stabilization feature, and said fluid interface device includes a second lateral stabilization feature that includes a first interengagement feature operatively associated with said movable band and a second interengagement feature operatively associated with at least one of said first and second roller elements, said first and second interengagement features dynamically engaging one another during use thereby resisting migration of said movable band in said widthwise direction.

17. An airfoil assembly according to claim 16, wherein said first interengagement feature includes an elongated ridge extending inward from along said inner face of said movable band, and said second interengagement feature includes an annular channel extending into at least one of said first and second roller elements with said annular channel dimensioned to receive at least a portion of said elongated ridge operatively engaging said at least one of said first and second roller elements.

18. An airfoil assembly according to claim 16, wherein one of:
said second interengagement feature includes an annular projection disposed along at least one of said first and second roller elements, and said first interengagement feature includes first and second sections of comparatively inextensible material disposed along said movable band, said first and second sections of comparatively inextensible material disposed along opposing sides of said annular projection thereby resisting migration of said movable band in said widthwise direction; and,
said second interengagement feature includes an annular recess disposed along at least one of said first and second roller elements, and said first interengagement feature includes a section of comparatively inextensible material disposed along said movable band, said section of comparatively inextensible material disposed within said annular recess thereby resisting migration of said movable band in said widthwise direction.

19. A fluid interface device dimensioned for securement along an associated airfoil structure and operable in an associated fluid such that relative movement between said fluid interface device and the associated fluid results in an associated fluid flow having an associated flow direction, the associated airfoil structure including an associated first side, an associated second side opposite the associated first side, an associated first longitudinal edge and an associated second longitudinal edge that is spaced apart from the associated first longitudinal edge in the associated flow direction, said fluid interface device comprising:
a first roller element disposed toward the associated first longitudinal edge;
a second roller element disposed in spaced relation to said first roller element toward the associated second longitudinal edge;
at least one movable band supported between said first and second roller elements, said at least one movable band oriented such that said at least one movable band is displaceable in relation to the associated flow direction with a surface portion of said at least one movable band exposed along one of the associated first side and the associated second side of the associated airfoil structure; and,
at least one lateral stabilization feature operatively associated with said at least one movable band and operable to oppose lateral migration-inducing forces on the at least one movable band experienced during use of said fluid interface device in operation.

20. A fluid interface device according to claim 19, wherein said at least one lateral stabilization feature includes a first interengagement feature operatively associated with said movable band and a second interengagement feature operatively associated with at least one of said first and second roller elements, said first and second interengagement features dynamically engaging one another during use thereby resisting migration of said movable band in said widthwise direction.
